(19) United States
(12) Patent Application Publication
(10) Pub. No.: US 2010/0270750 A1
(43) Pub. Date: Oct. 28, 2010

(54) SEAL FOR A GRATE COOLER

(75) Inventor: Karl Schinke, Koeln (DE)

Correspondence Address: GREER, BURNS & CRAIN, 300 S WACKER DR, 25TH FLOOR, CHICAGO, IL, 60606, US

(73) Assignee: KHD Humboldt Wedag GmbH, Koelin (DE)

(21) Appl. No.: 12/742,705

(22) PCT Filed: Dec. 11, 2008
(86) PCT No.: PCT/EP2008/067303

§ 371 Date: May 13, 2010

(30) Foreign Application Priority Data
Jan. 9, 2008 (DE) 10 2008 003 692.7

(51) Int. Cl. F16J 15/447; F16J 15/16

(52) U.S. Cl. 277/412; 277/345

(57) ABSTRACT

A seal for a grate cooler, in particular for a grate cooler that operates according to the Walking-Floor principle, the seal sealing two individual grate elements that move relative to one another against the penetration of cooled material between the individual grate elements, the seal having at least one individual sealing element.

### BACKGROUND OF THE INVENTION

The invention relates to a seal for a grate cooler, in particular for a grate cooler that operates according to the walking-floor principle, said seal sealing two individual grate elements, which are moveable one relative to the other, against the passage of cooling product between the individual grate elements, said seal comprising at least one individual sealing element.

In order to cool hot bulk material efficiently in a cooler, on the one hand it is necessary to introduce the cooling air as uniformly as possible to the hot bulk material and on the other hand it is necessary not to destroy a temperature gradient that is building up in the hot bulk material by means of the cooling. Both measures prevent cooling air that is still cooler joining with cooling air that has already been heated, and thus reducing the temperature difference between the cooling medium air and the hot bulk material to be cooled. Through an unwanted reduction in the temperature difference, there is a smaller flow of heat from the cooling product into the cooling air and consequently the cooling output of the cooler would be reduced by heating the cooling air that is still cooler.

Measures for the uniform introduction of the cooling air to the hot bulk material require the quantity of cooling air to be controlled in each zone of the cooler. Measures for maintaining the temperature gradient in the hot bulk material require that the hot bulk material has uniform resistance to the passage of the cooling air and that no so-called cold channels are created through which the cooling air passes at a higher density than through the hot zones, consequently not only impairing the efficiency of the cooler in an unwanted manner, but also reducing the temperature of the cooler exhaust air even more, thereby impairing the manner in which the cooler exhaust air, in its turn, is able to return the heat it has absorbed into the upstream process.

Reciprocating grate coolers or also travelling grate coolers are used to transport hot bulk material over a grate cooler. Said travelling grate coolers operate according to the walking-floor principle. A travelling grate cooler has a plurality of grate segments, which extend over the length of a section in the direction of transport, are adjacent each other and are moved together at a small stroke from one end of the grate cooler to the other end of the grate cooler. This means that the entire hot bulk material on the grate plates is transported in this direction. However, the return stroke of the individual grate segments does not occur in a synchronous manner, rather each individual grate segment is pulled back individually. The movement of an individual grate segment is not able to transport the entire bulk material back, but rather the bulk material lying on the relevant grate segment is held back in relation to the moving grate segment by adjacent bulk material that is in the rest position. In this case, the grate segment moving back slides back under the bulk material. If this operation is carried out for all the grate segments, then all the grate segments are situated in their initial position, however the bulk material has a net lag in the transport direction. If this operation is repeated frequently enough, the bulk material is transported in this way from one end to the other end of the entire grate.

Reciprocating grate coolers and also travelling grate coolers are also subject to increased wear and tear, as when the grate segments slide under the stationary bulk material, there is a considerable wearing effect on the grate segment caused by the hot, hard bulk material. In order to protect the surfaces of the grate segments, it is known to introduce cassettes into the grate segments in order to build up an autogenous wearing layer. Said autogenous wearing layer, however, cannot be built up in the immediate vicinity of a seal between two grate segments that can be moved one relative to the other. It has been shown that precise gap coverings and labyrinth seals have to be repaired frequently as they are really worn down by the operation.

### SUMMARY OF THE INVENTION

It is the object of the invention, consequently, to reduce the tendency of a grate cooler, in particular a travelling grate cooler, to create cold channels in the bulk material and at the same time to increase the service life of the seal.

The object according to the invention is achieved in that at least to one side of the seal there is a protection element that is moveable with the individual grate element, said protection element shielding the seal against a relative movement of an individual sealing element in relation to the cooling product.

It is provided according to the invention to protect such parts of the gap seal, between two individual grate elements that are moveable one relative to the other, against a relative movement in relation to the hot bulk material by means of a part that is entrainable with an individual grate element, said parts would wear with a movement of one grate segment, as one individual grate element, against the other grate segment, as another individual grate element, and also would mix bulk material structure lying thereon to be cooled and consequently would flatten the temperature gradient in the bulk material structure in the direction of passage of the cooling air. In the ideal case, the design of the seal according to the invention is to allow a transport of the bulk goods with no mixing and, as a result, no reduction in the cooler efficiency.

To understand the invention better it is necessary to understand the stroke process of the walking-floor principle. Inasmuch as the grate segments do not move in a synchronous manner with one another in the direction of transport, the bulk material rests on the grate segments and no relative movement mixing the bulk material layer and wearing the seal takes place. As soon as the return stroke of only one grate segment takes place in relation to other grate segments, only the grate segment moving back experiences a wearing movement, which, in its turn, leads to a mixing of the bulk material on the grate on account of the strong friction. With reference to the wear, the surfaces of the grate segments are protected by the cassettes with bulk material as an autogenous wearing protection layer. With reference to a mixing of the bulk material layer, the strong relative movement of the sealing elements sliding by one another leads to a rolling movement of the bulk material with a horizontal axis of rotation. If, by the grate segments moving backwards, parts of the seal come into direct contact with the bulk material layer, said parts are worn during the mixing process and the relative movements that involve a lot of friction. According to the invention, a protection element should be arranged at this point, said protection element being secured to the grate segment that at this moment is at rest. Consequently, the seal elements, protected by the protection plate which is at rest, can slide through under the protection plate and the bulk material layer lying there-above. If, contrary to this, the grate segment which is initially at rest is moved backwards, protection elements of the grate element moved in the first step protect the seal parts against too strong a relative movement and against wear.

In an advantageous development of the invention, the protection element is part of a labyrinth seal. In this development each protection element, each of which is secured to a grate segment, forms a meander-shaped sealing element, which engages around a corresponding second protection element. In this case, the alternate wrap-around is developed such that, in each case, a protection element with a grate segment at rest protects the protection element with a second grate segment in movement against the wearing relative movement with the bulk material on the grate segment that is at rest.

In a simple development, the seal is constructed from nested angle plates, which form the labyrinth seal. Said seal has a first angle plate, which is located over the length of the seal gap between individual grate elements and covers the seal gap. In this case, the first angle plate is arranged fixedly on a first individual grate element. A second angle plate, which is fixedly connected to a second individual grate element, shields the first angle plate in relation to relative movements in relation to the cooling material, which is on the second individual grate element.

In a particularly advantageous development of the invention, the protection element has means for self-cooling, so that the protection element does not wear prematurely on account of the heat of the bulk material to be cooled. In this case, it can be provided for cooling that cooling air is conducted to the protection element through a correspondingly large cross section on the underside of the grate segment and leaves the arrangement of protection device and seal into the bulk material. This means that the cooling air has to be introduced in a slightly less homogeneous manner. The advantages of the longer service life of the overall seal cancel out this disadvantage of the somewhat lower cooler efficiency.

It has also been proven as advantageous if means are provided for the mechanical adjustment of the spacing between protection element and seal. This means that tolerances in the position of the individual grate segments within the cooling grate can be balanced out. In the event of the labyrinth seal, the optimum adjustment can only be adjusted after assembly, thereby simplifying the nesting of the grate segments at assembly.

In the simplest case of the seal according to the invention, the protection element is fixedly connected to the corresponding grate segment. This can be performed by welding, riveting, screw-connecting or by any other type of connection. In a particular development of the invention, the protection element can be part of the grate segment, which is produced from a metal sheet, the protection element being formed by edge bending.

### BRIEF DESCRIPTION OF THE DRAWINGS

The invention is explained by way of the following figures, in which, in detail:

FIG. 1 shows a cross sectional view of a seal of a cooler from the prior art,

FIG. 2 shows a cross sectional view of a seal according to the invention,

FIG. 3 shows a cross sectional view of another embodiment of the seal according to the invention,

FIG. 4 shows a cross sectional view of another embodiment of the seal according to the invention.

### DETAILED DESCRIPTION OF THE DRAWINGS

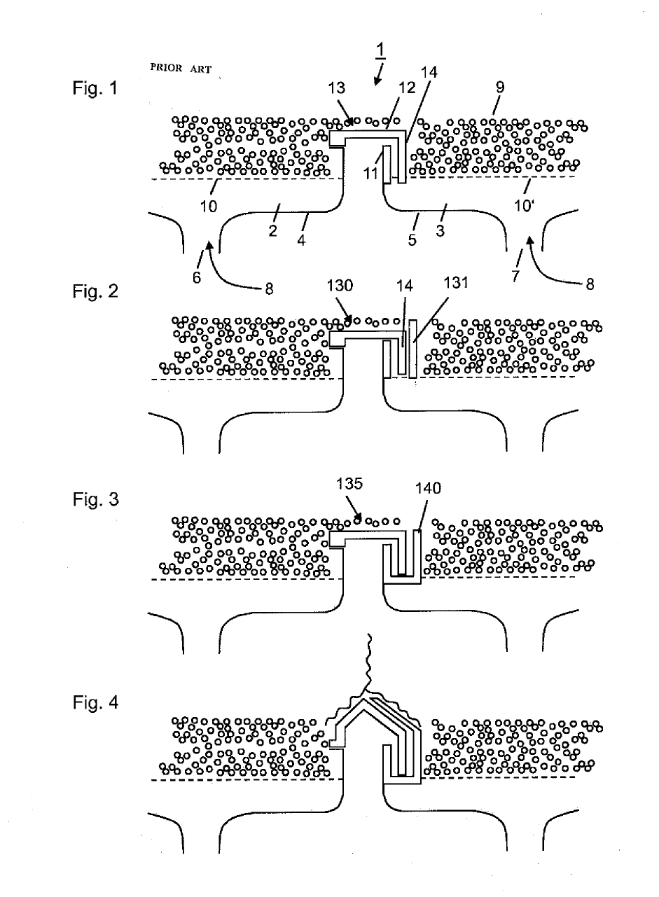

FIG. 1 shows a cross section through a travelling grate cooler 1, which includes in part two grate segments 2 and 3. The grate consists in each case of a lower support 4 and 5, each of which has an air inlet 6 and 7, through which cooling air 8 penetrates from below into the bulk material 9. The bulk material lies on a grid-like arrangement 10 and 10′ within the grate segments 2 and 3, the grid-like arrangement 10 and 10′ being permeable to the cooling air 8 and 9. The grate segments 2 and 3 represented in this figure are moved out of the paper plane and into the paper plane. In this case the two individual parts 11 and 12 of a prior art seal arrangement 13 move past each other. With this relative movement the seal edge 14 of the seal arrangement 13 thoroughly mixes the bulk material 9 in its immediate vicinity, thereby inducing the formation of a cold channel, which leads to a reduction in the cooler efficiency. In order to prevent this relative movement, it is provided according to the invention to locate a protection element at this point so that the thorough mixing can only still take place in a reduced manner.

The seal arrangement 130 in FIG. 2 differs from the seal arrangement 13 in FIG. 1 by the protection element 131, which protects the seal edge 14 against a relative movement of the seal edge 14 in relation to the bulk material 9 in the vicinity of the seal edge. This means that the bulk material 9 remains at rest in the vicinity of the seal edge 14 and does not form any cold channels as no mixing takes place which transports already cooled bulk material from the bottom to the top such that a narrow channel of already cooled bulk material 9 forms within the bulk material layer.

FIG. 3 shows an alternative embodiment of the seal according to the invention, the protection element 140 part being connected to the individual part 11 of the seal arrangement 135 and farming a U. This embodiment facilitates the design of the seal according to the invention. In this case it can be provided that means not shown in FIG. 3 are provided to adjust the spacing between the individual part 11 of the seal arrangement 135 and the protection element 14 in order to adapt the spacing after assembly to, where applicable, any structural tolerances.

In a particular development of the invention, the seal is meander-shaped in cross section and in this case the individual parts and the protection element are nested, as shown in FIG. 4. A fork-shaped construction is shown in cross section and this is to prevent a grate segment moving back having too strong a relative movement and consequently friction in relation to the resting bulk material of an adjacent grate segment in order to prevent the formation of cold channels in this manner. At the same time this design also leads to an increase in the service life of the seal according to the invention.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### List of References

1 Wall grate cooler
2 Grate segment
3 Grate segment
4 Support
5 Support
6 Air inlet
7 Air inlet
8 Cooling air
9 Bulk material
10 Grid-like arrangement
10′ Grid-like arrangement
11 Individual part of a seal
12 Individual part of a seal
13 Seal arrangement
14 Seal edge
131 Protection element
140 Protection element

1-6. (canceled)

7. A seal for a grate cooler, said seal sealing two individual grate elements, which are moveable one relative to the other, against the passage of cooling product between the individual grate elements, said seal comprising at least one individual sealing element, wherein at least to one side of the seal there is a protection element that is moveable with one of the individual grate elements, said protection element shielding the seal against a relative movement of the at least one individual sealing element in relation to the cooling product.

8. The seal as claimed in claim 7, wherein the grate cooler comprises a travelling grate cooler that operates according to the walking-floor principle.

9. The seal as claimed in claim 7, wherein the protection element is part of a labyrinth seal.

10. The seal as claimed in claim 7, wherein the protection element includes means for cooling

11. The seal as claimed in claim 7, wherein an air flow communication path leads from an underside of the grate segment towards the protection element and the seal to permit cooling air to flow over the protection element, the cooling air flowing from the protection element and seal through the cooling product.

12. The seal as claimed in claim 7, wherein the protection element includes a spacing adjustment mechanism to provide an adjustment of the spacing between the protection element itself and the at least one individual sealing element.

13. The seal as claimed in claim 7, wherein the protection element is fixedly connected to the individual grate element.

14. A seal for a grate cooler, said seal sealing two individual grate elements, which are moveable one relative to the other, against the passage of cooling product between the individual grate elements, said seal comprising a first angle plate, which is located over the length of the seal gap between individual grate elements and covers the seal gap, wherein the first angle plate is located in a fixed manner on a first individual grate element, and a second angle plate, which is fixedly connected to a second individual grate element, shields the first angle plate in relation to relative movements in relation to the cooling product that lies on the second individual grate element.

15. The seal as claimed in claim 14, wherein the grate cooler comprises a travelling grate cooler that operates according to the walking-floor principle.
